(19) United States
(12) Patent Application Publication
(10) Pub. No.: US 2004/0136441 A1
(43) Pub. Date: Jul. 15, 2004

(54) Frequency hopping system and method thereof

(76) Inventors: Joon-Gyu Ryu, Daejeon-city (KR); Hoon Jeong, Daejeon-city (KR); Ho-Jin Lee, Daejeon-city (KR); Deock-Gil Oh, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/746,520

(22) Filed: Dec. 23, 2003

(30) Foreign Application Priority Data
Dec. 23, 2002 (KR) 2002-0082857

(51) Int. Cl. H04B 1/713

(52) U.S. Cl. 375/135

(57) ABSTRACT

Disclosed is a frequency hopping system for converting frequencies of signals into RF (radio frequency) signals, which comprises: a frequency hopper for outputting signals with temporarily varied frequencies according to a predetermined pattern; a fixed PLL (phase locked loop) unit for outputting frequency-fixed signals; a mixer for mixing the output signals of the frequency hopper and the fixed PLL unit, and outputting frequency-hopped local signals; and a modulator for receiving I and Q (in-phase and quadrature-phase) signals from a baseband device, synthesizing the I and Q signals with the frequency-hopped local signals, combining the two synthesized signals, and outputting RF signals.

### CROSS REFERENCE TO RELATED APPLICATION

This application claims priority to and the benefit of Korea Patent Application No. 2002-82857 filed on Dec. 23, 2002 in the Korean Intellectual Property Office, the content of which is incorporated herein by reference.

### BACKGROUND OF THE INVENTION

(a) Field of the Invention

The present invention relates to a frequency hopping system and method. More specifically, the present invention relates to a frequency hopping system and method for broadband multimedia communication.

(b) Description of the Related Art

A satellite-based multimedia communication system provides broadband services. In particular, the European DVB-RCS (digital video broadcasting and return channel via satellite) standard for bidirectional satellite communication uses the MF-TDMA (multi-frequency time division multiple access) and the QPSK (quadrature phase shift keying) method for modulation, supports return links of 4 Mbps at a maximum, requires a hopping range of up to 20 MHz, and also requires fast frequency hopping of about a few hundred μseconds between time slots.

FIG. 1(a) shows a general frequency hopping system.

As shown, the frequency hopping system comprises a QPSK modulator 100, a frequency hopper 200 including a DDS (direct digital synthesizer), a DAC (digital to analog converter), a mixer 400, and an analog PLL (phase-locked loop) unit 300.

The QPSK modulator 100 phase-shifts the signal input from the DDS 200, mixes the phase-shifted signal with respective digital I and Q signals, adds the two signals, and outputs results. The DDS 200 is a frequency synthesizer using a direct frequency synthesizing method, and it solves the slow frequency hopping problem of the conventional PLL unit 300 and its fine frequency tuning difficulty, and accordingly, the DDS 200 is available for fast hopping and fine frequency tuning.

The DAC converts the digital signals output by the QPSK modulator 100 into analog signals, and outputs them.

The mixer 400 mixes the signal output by the DAC and a local oscillator signal output by the PLL unit 300 to generate RF (radio frequency) signals.

The conventional frequency hopping system has realized modulation and frequency hopping functions at a digital unit, which is before the DAC. That is, the frequency hopping system performs in-phase and quadrature-phase modulation on the digital signals, and mixes them with the signals output by the DDS 200 to generate low IF (intermediate frequency) signals.

However, it is difficult to generate high frequency signals at the digital unit of FIG. 1, and the RF signals are generated by mixing the analog PLL signals with the generated low IF signals and performing frequency up-conversion on them at the mixer 400.

The above-output RF signals have frequency up-converted signals of the IF signals and the analog PLL signals together. Since the intervals between the analog PLL signals and the RF signals are very adjacent, spurious characteristics of output signals are worsened when obtaining desired frequency signals by using a filter, and hence, it is difficult to eliminate the analog PLL signals.

That is, as shown in FIG. 1(b), the distance A between the center of the RF signal which is a modulation signal having a predetermined bandwidth and that of the analog PLL signal is comparatively far, but the distance B between the edge of the RF signal and the analog PLL signal is near. Therefore, it is needed to use an excellent filter so as to eliminate the analog PLL signals, and hence, the cost of a terminal increases and the size of the filter becomes larger to enlarge the size of the terminal. Also, it is unsuitable for the conventional frequency hopping system to transmit broadband multimedia signals since the broadband signals have a closer distance between the RF signals and the analog PLL signals.

### SUMMARY OF THE INVENTION

It is an advantage of the present invention to provide a frequency hopping system and method for making the size of the terminal smaller and allowing faster frequency hopping when transmitting broadband multimedia signals.

In one aspect of the present invention, a frequency hopping system for converting frequencies of signals into RF signals, comprises: a frequency hopper for outputting signals with temporarily varied frequencies according to a predetermined pattern; a fixed PLL (phase locked loop) unit for outputting frequency-fixed signals; a mixer for mixing the output signals of the frequency hopper (DDS) and the fixed PLL unit, and outputting frequency-hopped local signals; and a modulator for receiving I and Q (in-phase and quadrature-phase) signals from a baseband device, synthesizing the I and Q signals with the frequency-hopped local signals, combining the two synthesized signals, and outputting RF signals.

The system further comprises first and second DACs (digital to analog converters) for converting the I and Q signals output by the baseband device into analog signals, and outputting them to the modulator.

The frequency hopper converts the frequency and outputs results by using the DDS (direct digital synthesis) method.

In another aspect of the present invention, a frequency hopping method for converting frequencies of signals into RF signals, comprises: (a) mixing signals with temporarily varied frequencies and frequency-fixed signals according to a predetermined pattern, and generating frequency-hopped local signals; and (b) synthesizing I and Q signals output from a baseband device with the frequency-hopped local signals, combining the two synthesized signals, and outputting RF signals.

The step (b) comprises converting the I and Q signals output by the baseband device into analog signals.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIGS. 1(a) and 1(b) show a conventional frequency hopping system and output signals; and

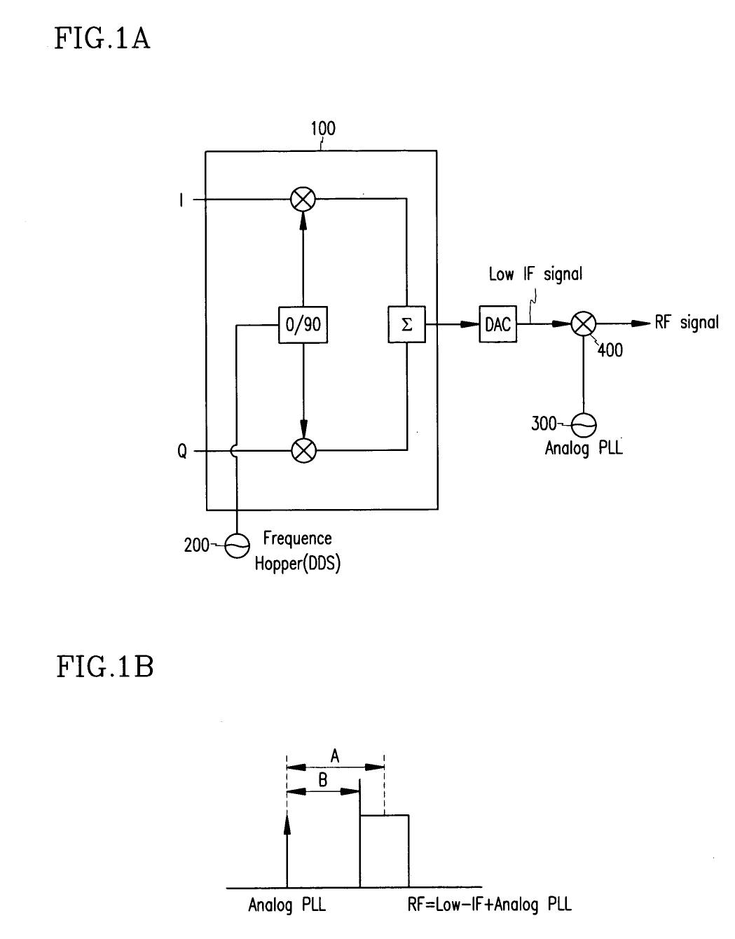

FIGS. 2(a) and 2(b) show a frequency hopping system and output signals according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

To reduce the size of terminals, recent radio communication systems use the direct conversion method of generating RF signals from in-phase and quadrature-phase signals I and Q which are digitally encoded from the RF signals without converting them to IF signals. In the preferred embodiment of the present invention, the direct conversion method is used to mix signals of the frequency hopper 200 and those of the analog PLL unit 300 and realize fast broadband frequency hopping.

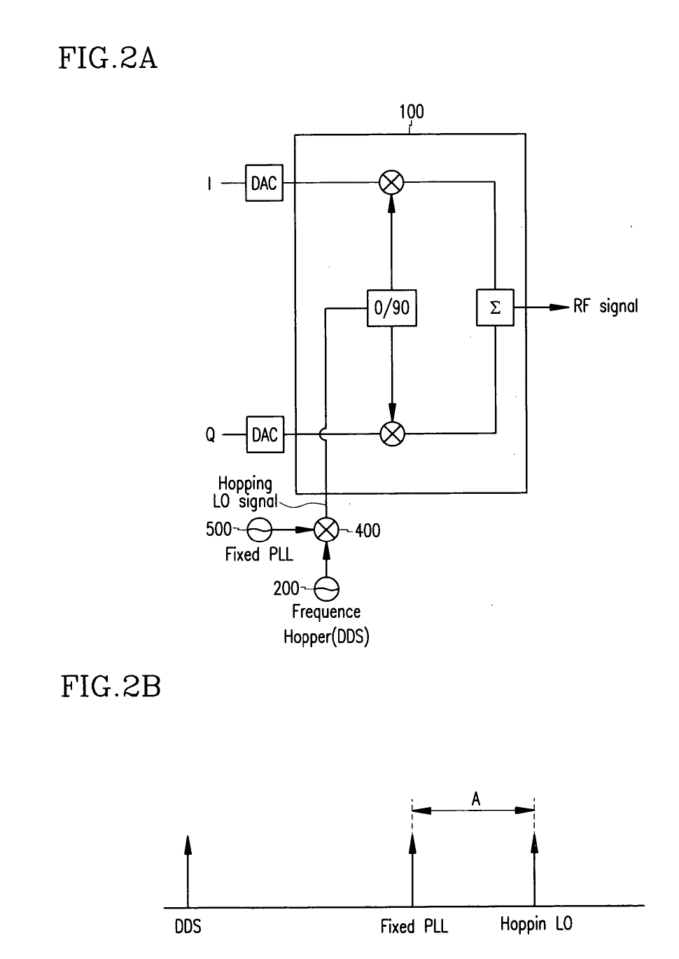

FIG. 2(a) shows a frequency hopping system according to a preferred embodiment of the present invention.

As shown, the frequency hopping system comprises a QPSK modulator 100, a frequency hopper 200 including a DDS, a mixer 400, and a fixed PLL unit 500 for outputting frequency-fixed signals. I and Q signal input terminals of the QPSK modulator 100 are respectively coupled to a DAC.

An operation of the frequency hopping system will now be described.

I and Q signals input to the QPSK modulator 100 are converted into analog signals by the DACs. Output signals of the frequency hopper 200 are mixed with output signals of the fixed PLL unit 500 at the mixer 400, and mixed signals are input to the QPSK modulator 100.

The QPSK modulator 100 phase-modulates the mixed signals, mixes them with the respective analog-converted I and Q signals, performs summation on them, and generates RF signals.

That is, when frequency-converting the digital I and Q signals into RF signals through the direct conversion method without converting them into IF signals, the frequency hopping system mixes signals of the fixed PLL unit 500 and the frequency hopper 200 to generate hopping LO (local oscillator) signals which are frequency-converted output signals. When receiving the hopping LO signals, the QPSK modulator 100 outputs RF signals which have excellent spurious characteristics.

FIG. 2(b) shows a process for generating hopping LO signals.

As shown, since the output signals of the frequency hopper 200 and those of the fixed PLL unit 500 are not modulated, the interval between the hopping LO signals generated by the two signals' frequency conversion and the fixed PLL signals is wide. Therefore, the fixed PLL signals are easily eliminated in the case of using a small filter with ordinary characteristics.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described, since the output signals of the frequency hopper and the signals of the fixed PLL unit are frequency-converted, and frequency-hopped at the analog end, fast frequency hopping is possible in the broad bands. Also, since the RF signals are directly extracted from the digitally encoded in-phase and quadrature-phase I and Q signals by using the direct conversion method without converting them to IF signals, the size and cost of the terminal are reduced.

What is claimed is:

1. A frequency hopping system for converting frequencies of signals into RF (radio frequency) signals, comprising:
a frequency hopper for outputting signals with temporarily varied frequencies according to a predetermined pattern;
a fixed PLL (phase locked loop) unit for outputting frequency-fixed signals;
a mixer for mixing the output signals of the frequency hopper and the fixed PLL unit, and outputting frequency-hopped local signals; and
a modulator for receiving I and Q (in-phase and quadrature-phase) signals from a baseband device, synthesizing the I and Q signals with the frequency-hopped local signals, combining the two synthesized signals, and outputting RF signals.

2. The system of claim 1, further comprising: first and second DACs (digital to analog converters) for converting the I and Q signals output by the baseband device into analog signals, and outputting them to the modulator.

3. The system of claim 1, wherein the frequency hopper converts the frequency and outputs results by using the DDS (direct digital synthesis) method.

4. A frequency hopping method for converting frequencies of signals into RF (radio frequency) signals, comprising:
(a) mixing signals with temporarily varied frequencies and frequency-fixed signals according to a predetermined pattern, and generating frequency-hopped local signals; and
(b) synthesizing I and Q (in-phase and quadrature-phase) signals output from a baseband device with the frequency-hopped local signals, combining the two synthesized signals, and outputting RF signals.

5. The method of claim 4, wherein (b) comprises converting the I and Q signals output by the baseband device into analog signals.
